(19) United States
(12) Patent Application Publication
(10) Pub. No.: US 2007/0262958 A1
(43) Pub. Date: Nov. 15, 2007

(54) Finger-worn input device and input method applying the same

(75) Inventors: Zheng-Zhe Cai, San Chung (TW); Zhen-Bang Chen, San Chung (TW); Zhong-Nan Wang, San Chung (TW); Li-Wen Lin, San Chung (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: KYE Systems Corporation

(21) Appl. No.: 11/711,148

(22) Filed: Feb. 27, 2007

(30) Foreign Application Priority Data
Apr. 19, 2006 (TW) 095113890

(51) Int. Cl. G06F 3/033

(52) U.S. Cl. 345/158

(57) ABSTRACT

The present invention relates to a finger-worn input device, which comprises a movement detecting unit, a main controller and a connection structure. After being assembled, users can insert their finger in between the movement detecting unit and the main controller in order to move the movement detecting unit and to press a key. The main controller receives a movement signal and a key signal, converts these signals into a computer control signal, which is then transmitted to a computer for further process through a wired or wireless transmission method. By using the finger-worn input device with the structure mentioned above, the user usage is more convenient and the input device can be minimized. In addition, the present invention also discloses an input method applying the finger-worn input device.

### BACKGROUND OF THE INVENTION

1. Field of the Invention

The present invention relates to an input device, and more particularly, to a finger-worn input device for the users that are using the computer mouse/input device to control the computer cursor on any surface without having to grab the input pointing device while typing on the keyboard, so as to improve the user convenience, and an input method applying the finger-worn input device.

2. Description of the Related Art

The computer mouse/input device of the current market usually configures a movement detecting unit and a controller inside its main body. While being used, the computer mouse/input device is moved by the user to a desired position and a button located thereon is pressed down, such that the controller can transmit a movement movement to a computer for further process.

Regarding to the related techniques, please refer to public patent information disclosed in the approved ROC Patent No. 443542 (applied on Dec. 18, 1998 and published on Jun. 23, 2001) and the U.S. Pat. No. 5,706,026 (applied on Mar. 13, 1995 and published on Jan. 6, 1998).

Although the technique of operating the finger-controlled mouse had been proposed in the prior art in the ROC Patent No. 443542 and the U.S. Pat. No. 5,706,026 mentioned above, a finger stall is commonly provided for users to be worn on the user's finger, and the track detector is disposed on the tip of the finger stall. While being used, the users have to insert their finger into the finger stall in order to move the fingertip to a desired position and to press an input key on its side. After processing by a circuit unit, a signal is transmitted to a computer through a signal output unit for further process. The patents mentioned above have the following disadvantages: (1) While it is being used, the users have to insert their finger into the finger stall, and after long usage, the user's finger will feel uncomfortable; (2) in the U.S. Pat. No. 5,706,026, the controller unit is worn on the user's wrist and the finger stall is connected to the controller unit through an electric wire, but the electric wire will most likely block the finger's way.

Therefore, it is desired to have a finger-worn input device for the users that are using the computer mouse/input device to control the computer cursor on any surface without having to grab the input pointing device while typing on the keyboard, so as to improve the user convenience and to resolve the disadvantage of the conventional finger-controlled input device product.

### SUMMARY OF THE INVENTION

Therefore, it is an objective of the present invention to provide a finger-worn input device and an input method applying the same, in which the movement detecting unit and the main controller are disposed separately. With such device, the users can easily control the computer cursor on any surface without having to grab the input pointing device while typing on the keyboard, so as to improve the user convenience.

It is another objective of the present invention to provide a finger-worn input device and an input method applying the same, which only requires a smaller operation area and allows the user to operate on any surface such as a tiny operation desktop, small surface on appliance and object, front end platform of the laptop, surface of human's skin, clothes and materials without being limited by the user environment, so as to resolve the disadvantage of requiring a larger operation desktop in the conventional mouse environment.

It is another objective of the present invention to provide a finger-worn input device and an input method applying the same, which requires a smaller operation desktop and the users will not be limited by the user environment. It also allows the users of the computer mouse to easily switch operation between keyboard and mouse, and allows the users of the portable computer (e.g. the laptop or notebook) to normally operate the mouse on a smaller operation desktop without having to change their habit of operating the same.

To achieve the foregoing objectives, a finger-worn input device is provided by the present invention, which comprises: a movement detecting unit, on which a movement detector and at least a key are configured, the movement detector is used to detect a movement signal and the key will generate a key signal while it is triggered; a main controller, which is disposed above the movement detecting unit and comprises at least a controller and an interface circuit; and a connection structure, which connects the movement detecting unit and the main controller. After being assembled, users can insert their finger in between the movement detecting unit and the main controller in order to move the movement detecting unit and to press the key. The controller receives the movement signal and the key signal and converts these signals into a computer control signal, which is then transmitted to a computer for further process through the interface circuit.

To achieve the foregoing objectives, a finger-worn input device is provided by the present invention, which comprises: a movement detecting unit, on which a movement detector and at least a key are configured, the movement detector is used to detect a movement signal and the key will generate a key signal while it is triggered; a main controller, which is disposed above the movement detecting unit and comprises at least a controller and a wireless transmission module; and a connection structure, which connects the movement detecting unit and the main controller. After being assembled, users can insert their finger in between the movement detecting unit and the main controller in order to move the movement detecting unit and to press the key. The controller receives the movement signal and the key signal and converts these signals into a computer control signal, which is then transmitted to a computer's wireless receiver for further process through the wireless transmission module.

To achieve the foregoing objectives, an input method applying the finger-worn input device is provided by the present invention. The input method comprises the following steps: providing a movement detector unit, a main controller, and a connection structure, wherein, a movement detector and at least a key are configured on the movement detecting unit, the movement detector is used to detect a movement signal and the key will generate a key signal while it is triggered, the connection structure connects the movement detecting unit and the main controller so as to form a finger-worn input device in which the main controller is disposed above the movement detecting unit; inserting the user's finger in between the movement detecting unit and the main controller; and moving the movement detecting unit and pressing the key, afterwards, the controller receiving the movement signal and the key signal and converting these signals into a computer control signal, which is then transmitted to a computer for further process.

### BRIEF DESCRIPTION OF THE DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a schematic composition diagram of a finger-worn input device according to a preferred embodiment of the present invention.

FIG. 2 is a schematic diagram showing the usage of the finger-worn input device provided by the present invention.

FIG. 3 is a schematic diagram showing the connection between the finger-worn input device of the present invention and a computer.

FIG. 4 is a schematic diagram of a finger-worn input device according to another preferred embodiment of the present invention.

FIG. 5 is a schematic diagram of a finger-worn input device according to yet another preferred embodiment of the present invention.

FIG. 6 is a schematic diagram of a finger-worn input device according to still yet another preferred embodiment of the present invention.

FIG. 7 is a schematic diagram showing an application example of a physical product provided by the present invention.

FIG. 8 schematically shows a flow chart illustrating the steps of an input method applying the finger-worn input device according to another preferred embodiment of the present invention.

### DETAILED DESCRIPTION OF THE PREFERRED EMBODIMENTS

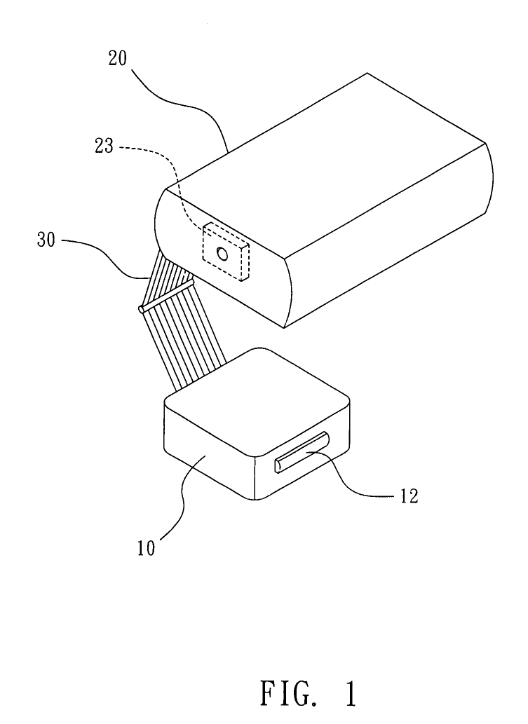

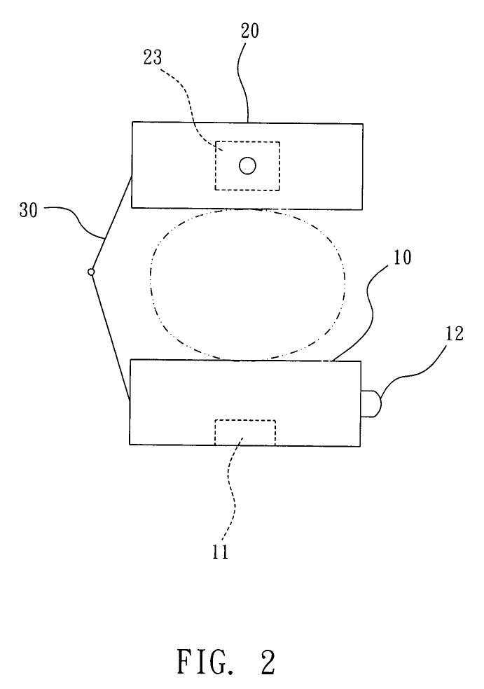

Referring to FIGS. 1 and 2, wherein FIG. 1 is a schematic composition diagram of a finger-worn input device according to a preferred embodiment of the present invention, and FIG. 2 is a schematic diagram showing the usage of the finger-worn input device provided by the present invention. As shown in FIG. 1, the finger-worn input device of the present invention comprises a movement detecting unit 10; a main controller 20; and a connection structure 30.

A movement detector 11 and at least a key 12 are configured on the movement detecting unit 10. Wherein, the movement detector 11 is disposed on the bottom of the movement detecting unit 10 to detect a movement signal, and the key 12 is disposed in the inner or outer side of the movement detecting unit 10, for example but not limited, it is on the right side or the inner side when the user's finger is inserted therein. While it is triggered, the key 12 will generate a key signal.

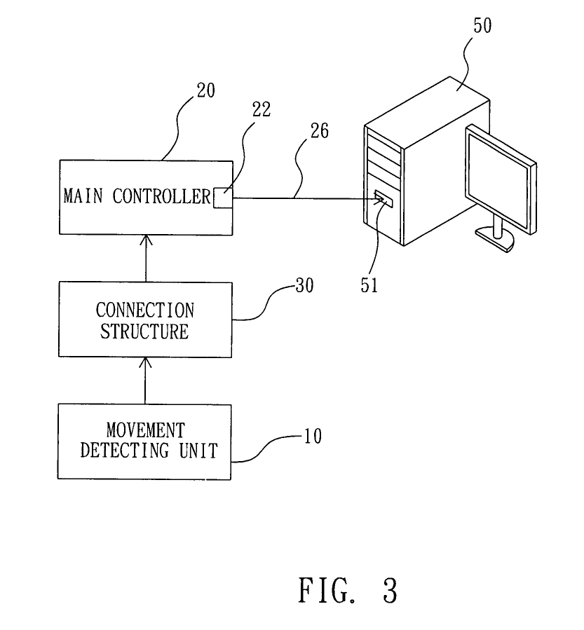

The main controller 20 is disposed above the movement detecting unit 10 and at least comprises a controller 21 and an interface circuit 22. In addition, the interface circuit 22, is for example, but not limited to a USB, PS/2 or RS-232 interface (please refer to the description of FIG. 3).

The connection structure 30 is used to connect the movement detecting unit 10 and the main controller 20. Besides the structure connecting to the movement detecting unit 10 and the main controller 20, the connection structure 30 further comprises a signal transmission line that is used to transmit the movement signal and the key signal to the main controller 20. The connection structure 30 is preferably connected to the other side of the movement detecting unit 10 where the key 12 is not configured thereon, and for example but not limited, it may be connected to the left side so as not to block the user from pressing the key 12. Wherein, the connection structure 30 may be a structure that has elasticity or can generate stress. To be noted, besides installing on the outer side of the movement detecting unit 10, the key 12 may be also installed on the inner side of the movement detecting unit 10, on the connection structure 30, or on any inner or outer side of the main controller 20, so as to facilitate the users in using different functions.

As shown in FIG. 2, after being assembled, the users can insert their finger in between the movement detecting unit 10 and the main controller 20 in order to move the movement detecting unit 10 to the appropriate position and to press the key 12. Meanwhile, the key 12 will send the key signal out, and the movement detector 11 will send the movement signal to the controller 21. Then, the movement signal and the key signal are received by the controller 21 and converted to a computer control signal, and then transmitted to a computer 50 through the interface circuit 22 for further process (please refer to FIG. 3). Wherein, the computer 50 is for example, but not limited to a desktop computer, a laptop computer or various portable devices such as mobile phones and PDA. Therefore, in the finger-worn input device of the present invention, the movement detecting unit 10 and the main controller 20 are separately disposed, such that the size of the movement detector 11 can be reduced, and the user can easily operate on any surface such as a tiny operation desktop, small surface on appliance and object, front end platform of the laptop, surface of human's skin, clothes and materials without being limited by the user environment, so as to resolve the disadvantage of requiring a larger operation desktop in the conventional mouse environment.

In addition, the main controller 20 of the present invention further comprises a laser pan module 23, which is coupled to the key 12 of the movement detecting unit 10. While the key 12 is being pressed, the laser pan module 23 emits a laser beam, such that the finger-worn input device of the present invention can be used as a laser pointing device. To be noted, the laser pan module 23 may be disposed on the front end of the movement detecting unit 10, the connection structure 30 or the main controller 20.

FIG. 3 is a schematic diagram showing the connection between the finger-worn input device of the present invention and a computer. As shown in the drawing, the interface circuit 22 of the present invention is for example, but not limited to a USB, PS/2 or RS-232 interface. A cable 26 that is corresponded to the wired interface and connected to the interface circuit 22 is also provided. Wherein, the cable is for example, but not limited to a USB, PS/2 or RS-232 cable 24. While being used, after the cable 24 is connected to a corresponding connection port 51 of the computer 50, the operation of the finger-worn input device of the present invention can be commenced.

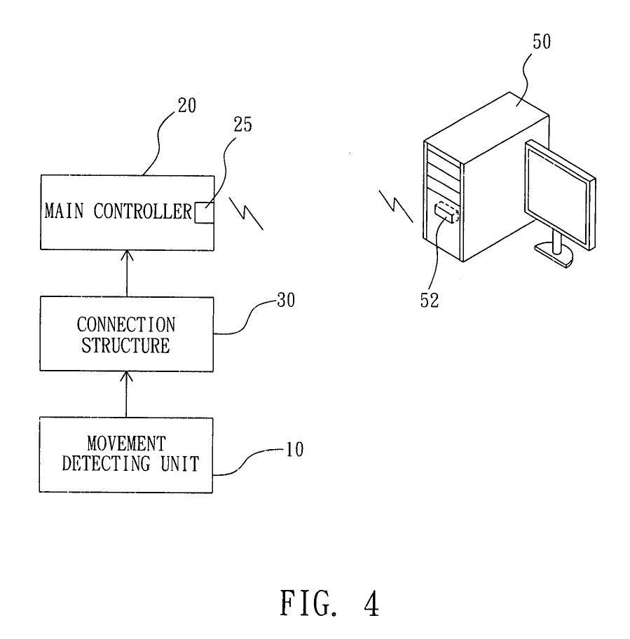

FIG. 4 is a schematic diagram of a finger-worn input device according to another preferred embodiment of the present invention. As shown in the drawing, the finger-worn input device of the present invention may transmit the movement signal and the key signal to the computer through a wireless method. The finger-worn input device comprises a movement detecting unit 10, a main controller 20, and a connection structure 30. The present embodiment differs from the previous embodiment in that a wireless transmission module 25 is configured in the main controller 20 to replace the interface circuit 22, and the computer 50 has a corresponding wireless receiving device 52. Since the structure and function of the movement detecting unit 10 and the connection structure 30 in the present embodiment is the same as in the previous embodiment, its detail is intentionally omitted herein. Wherein, the wireless transmission module 25, comprises but is not limited to a RF (Radio frequency) module, a wireless network module, an IR (infrared) module, an ultrasonic wave module, or other similar wireless modules such as the 27 MHz, Bluetooth, and 802.11, . . . , etc.

While being used, after the user had inserted their finger in between the movement detecting unit 10 and the main controller 20, the wireless finger-worn input device of the present invention begins to operate. Meanwhile, the wireless transmission module 25 emits the key signal that is generated when the user presses the key and the movement signal detected by the movement detector 11 to the receiving device 52 of the computer 50. Then, the computer 50 processes the received movement signal and the key signal.

In addition, the finger-worn input device of the present invention further comprises a laser pan module 23, which is coupled to the key 12 of the movement detecting unit 10. While the key 12 is being pressed, the laser pan module 23 emits a laser beam, such that the finger-worn input device of the present invention can be used as a laser pointing device.

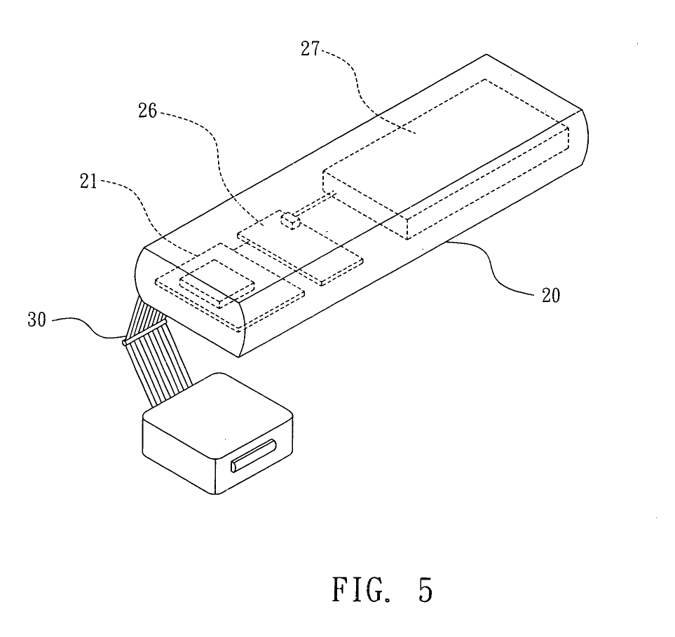

FIG. 5 is a schematic diagram of a finger-worn input device according to yet another preferred embodiment of the present invention. As shown in the drawing, the main controller 20 of the wireless finger-worn input device provided by the present invention further comprises a charging circuit 26 and a chargeable battery 27. The main controller 20 is connected to the computer 50 through an interface circuit 26. The charging circuit 26 is coupled to the controller 21 and the chargeable battery 27 for receiving the control from the controller 21 to charge the chargeable battery 27 with the electricity of the computer 50, and the electricity power required to normally operate the finger-worn input device is supplied by the chargeable battery 27.

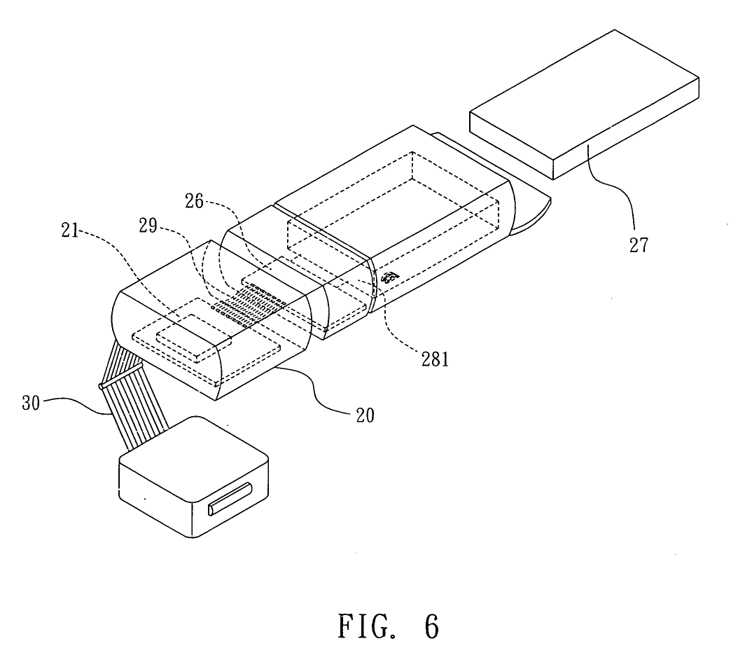

FIG. 6 is a schematic diagram of a finger-worn input device according to still yet another preferred embodiment of the present invention. As shown in the drawing, the main controller 20 of the wireless finger-worn input device provided by the present invention further comprises a chargeable battery cartridge 27, which comprises a plurality of battery elastic flakes or contacts 281 for accommodating and coupling to an external chargeable battery 27 or a general consumable battery. The main controller 20 can also be connected to the computer 50 through an interface circuit 26. Wherein, the chargeable battery cartridge 28 is coupled to the main controller 20 through a connector 29, and the charging circuit 26 can charge the chargeable battery 27 through the connector 29. The chargeable battery 27 or the general battery can provide the electricity power to the finger-worn input device. Wherein, the chargeable battery 27, is for example, but not limited to a Lithium chargeable battery, a NiMH chargeable battery, or a Lithium & Magnesium chargeable battery.

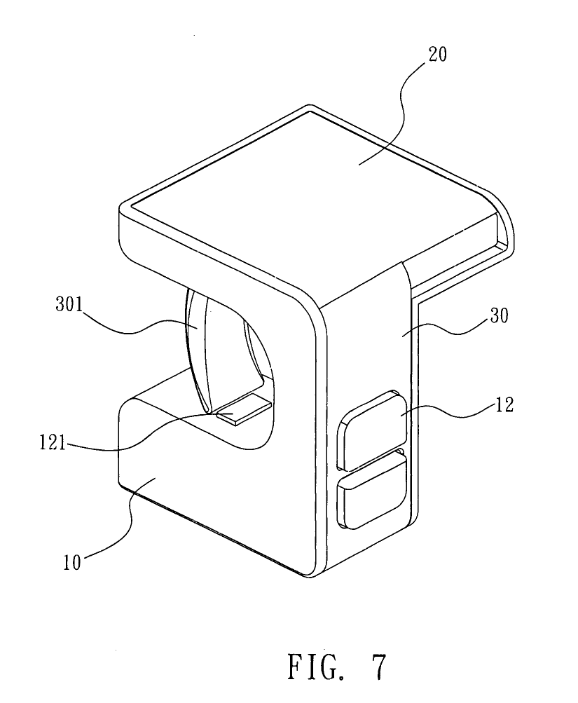

FIG. 7 is a schematic diagram showing an application example of a physical product provided by the present invention. Wherein, the users can insert any of their fingers in between the movement detecting unit 10 and the main controller 20, and the movement detecting unit 10 is connected to the main controller 20 through a connection structure 30 so as to form an integrated piece. The key 12 may be disposed on the outer side of the movement detecting unit 10 or the connection structure 30. Alternatively, a key 121 may be configured on the inner side of the movement detecting unit 10 to receive the press from the inner part of the user's finger. For example, the key 121 on the inner side can emulate the left key function of the general mouse, and the key 12 on the outer side can emulate the mouse's right key function.

The inner side of the connection structure 30 may be designed as a curve surface (not shown) to adapt with the finger shape, and an elastic hook 301 may be further configured on the place corresponding to the curve surface, such that the user's finger can be comfortably placed and locked in between the main controller 20 and the movement detecting unit 10.

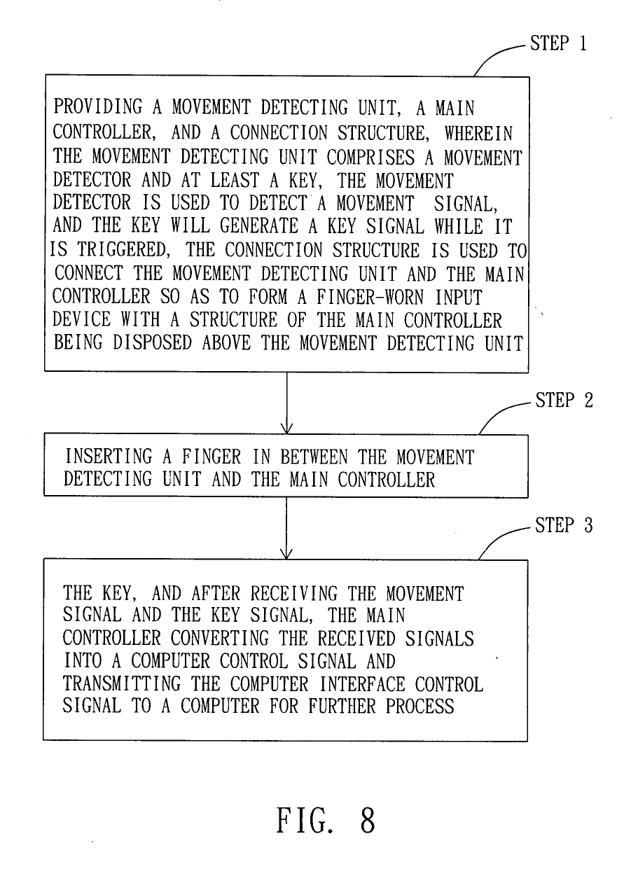

FIG. 8 schematically shows a flow chart illustrating the steps of an input method applying the finger-worn input device according to another preferred embodiment of the present invention. As shown in the drawing, the input method of the finger-worn input device provided by the present invention comprises the following steps: providing a movement detecting unit 10, a main controller 20, and a connection structure 30, wherein the movement detecting unit 10 comprises a movement detector 11 and at least a key 12, the movement detector 11 is used to detect a movement signal, and the key 12 will generate a key signal while it is triggered, the connection structure 30 is used to connect the movement detecting unit 10 and the main controller 20 so as to form a finger-worn input device with a structure of the main controller 20 being disposed above the movement detecting unit 10 (step 1); inserting a finger in between the movement detecting unit 10 and the main controller 20 (step 2); and moving the movement detecting unit 10 and pressing the key 12, and after receiving the movement signal and the key signal, the main controller 20 converting the received signals into a computer control signal and transmitting the computer control signal to a computer for further process (step 3).

Wherein, in the movement detecting unit 10, the main controller 20, and the connection structure 30 of step 1, a movement detector 11 and at least a key 12 are configured on the movement detecting unit 10. The movement detector 11 is used to detect a movement signal, and the key 12 will generate a key signal while it is triggered. The connection structure 30 is used to connect the movement detecting unit 10 and the main controller 20 so as to form a finger-worn input device with a structure of the main controller 20 being disposed above the movement detecting unit 10. Please refer to the foregoing description for its details, which is intentionally omitted herein.

For the details of the step 2 of inserting the finger in between the movement detecting unit 10 and the main controller 20, please refer to the foregoing description, which is intentionally omitted herein.

In step 3 of moving the movement detecting unit 10 and pressing the key 12, and after receiving the movement signal and the key signal, the main controller 20 converting the received signals into a computer control signal and transmitting the computer control signal to a computer for further process, wherein the main controller 50 may transmit the movement signal and the key signal to the computer 50 in either a wired or a wireless way, and please refer to the foregoing description for its details, which is intentionally omitted herein. Therefore, the input method of the finger-worn input device provided by the present invention indeed improves the disadvantage of the conventional input device.

In summary, by applying the embodiments of the present invention, the movement detecting unit and the main controller are separately disposed, such that the users can easily control the computer cursor on any surface without having to grab the input pointing device while typing on the keyboard. Accordingly, the user convenience is improved and the disadvantage of the conventional input device is resolved.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A finger-worn input device for wearing on a finger of a user and exposing a tip of said finger, comprising:
a movement detecting unit having a movement detector for detecting and generating a movement signal;
at least a key for generating a key signal while being triggered on;
a main controller disposed above said movement detecting unit and comprising at least a controller and an interface circuit; and
a connection structure for connecting said movement detecting unit and said main controller;
after being assembled, a user inserting a finger in between said movement detecting unit and said main controller and a tip of said finger being exposed; moving said movement detecting unit and/or pressing said key, after receiving said movement signal and/or said key signal, said controller converting said signals into a control signal and then transmit said control signal to a computer through said interface circuit.

2. The finger-worn input device as claimed in claim 1, wherein said movement detector is disposed on the bottom of said movement detecting unit, and said key is disposed on any side of said movement detecting unit, said main controller or said connection structure.

3. The finger-worn input device as claimed in claim 1, wherein said interface circuit may be a USB interface, a PS/2 interface or a RS-232 interface.

4. The finger-worn input device as claimed in claim 1, wherein in addition to a structure for connecting said movement detecting unit and said main controller, said connection structure further comprises a signal transmission line for transmitting said movement signal and said key signal to said main controller.

5. The finger-worn input device as claimed in claim 4, wherein said connection structure may be a structure that has elasticity or can generate stress.

6. The finger-worn input device as claimed in claim 1, wherein said main controller further comprises a laser pan module that is coupled to said key of said movement detecting unit, while said key is being pressed, said laser pan module emits a laser beam.

7. A finger-worn input device for wearing on a finger of a user and exposing a tip of said finger, comprising:
a movement detecting unit having a movement detector for detecting a movement signal;
at least a key for generating a key signal while being triggered on;
a main controller disposed above said movement detecting unit and comprising at least a controller and a wireless transmission module; and
a connection structure for connecting said movement detecting unit and said main controller; and
at least a battery for providing the electricity power required for said movement detecting unit and said main controller;
after being assembled, a user inserting a finger in between said movement detecting unit and said main controller and a tip of said finger being exposed; moving said movement detecting unit and/or pressing said key, after receiving said movement signal and/or said key signal, said controller converting said signals into a control signal and then transmit said control signal to a computer through said wireless transmission module.

8. The finger-worn input device as claimed in claim 7, wherein said movement detector is disposed on the bottom of said movement detecting unit, and said key is disposed on any side of said movement detecting unit, said main controller or said connection structure.

9. The finger-worn input device as claimed in claim 7, wherein said main controller further comprises a laser pan module that is coupled to said key of said movement detecting unit, while said key is being pressed, said laser pan module emits a laser beam.

10. The finger-worn input device as claimed in claim 7, wherein said main controller further comprises a charging circuit, and said battery is a chargeable battery; said charging circuit is coupled to said controller and said chargeable battery, and said main controller is coupled to said computer through an interface circuit, such that said chargeable battery can be charged with the electricity power of said computer through said interface circuit and said charging circuit.

11. The finger-worn input device as claimed in claim 7, wherein said main controller comprises a battery cartridge for accommodating said battery.

12. The finger-worn input device as claimed in claim 7, wherein said connection structure further comprises a hook structure.

13. An input method of a finger-worn input device, comprising:
providing a movement detector unit, a main controller, and a connection structure, wherein, a movement detector and at least a key are configured on said movement detecting unit, said movement detector detects a movement signal and said key generates a key signal while it is triggered, and said connection structure connects said movement detecting unit and said main controller so as to form a finger-worn input device in which said main controller is disposed above said movement detecting unit;
inserting a finger in between said movement detecting unit and said main controller; and
moving said movement detecting unit and pressing said key, after receiving said movement signal and said key signal, said controller converts said signals into a computer control signal and transmits said computer control signal to a computer for further process.
